(19) United States
(12) Patent Application Publication
(10) Pub. No.: US 2022/0395846 A1
(43) Pub. Date: Dec. 15, 2022

(54) COAL-CONTAINING WASTEWATER SPRAYING DEVICE FOR DUST SUPPRESSION DURING COAL CONVEYING

(71) Applicant: HUANENG POWER INTERNATIONAL,INC.SHANGHAI SHIDONGKOU FIRST POWER PLANT, Shanghai (CN)

(72) Inventors: Xiao ZHANG, Shanghai (CN); Xin HU, Shanghai (CN); Ping ZHU, Shanghai (CN); Feng HAN, Shanghai (CN); Wenyue ZHAO, Shanghai (CN); Runhan LIU, Shanghai (CN)

(21) Appl. No.: 17/447,431

(22) Filed: Sep. 12, 2021

(30) Foreign Application Priority Data
Jun. 11, 2021 (CN) 202110651570.7

(51) Int. Cl. B05B 3/04; B65G 69/18

(52) U.S. Cl. CPC B05B 3/0422; B65G 69/188

(57) ABSTRACT

Provided is a coal-containing wastewater spraying device for dust suppression during coal conveying, including a motor, a gland, a body seat, and an accelerator. The body seat includes a funnel-shaped cover, a first disc and a plurality of crushing plates. The accelerator includes a circular second disc. The end of an output shaft of the motor passes through the first disc to connect with the second disc. The cover is provided with a water retaining ring between the first disc and the second disc along its axial direction. The cover, the first disc, the second disc and the water retaining ring form a water inlet space.

### CROSS-REFERENCE TO RELATED APPLICATIONS

This application claims priority benefits to Chinese Patent Application No. 202110651570.7, filed on Jun. 11, 2021. The contents of the aforementioned application are incorporated herein by reference.

### TECHNICAL FIELD

The present disclosure relates to a technology for dust suppression during coal conveying, in particular to a coal-containing wastewater spraying device for dust suppression during coal conveying.

### BACKGROUND

Coal conveying is accomplished by means of various conveying equipment in industry, in the conveying process, coal flying dust is always produced, coal accumulation also always occur in the conveying equipment and site, some of these flying dusts are produced during conveying and transfer, some of these flying dusts will be scattered on the coal conveying site, sometimes, equipment failure will also cause the conveyed coal to be scattered on the site, and these coal flying dusts and accumulated coal not only pollute the environment, but also some coal is very prone to spontaneous combustion, which may induce fire and endanger the safety of coal conveying production.

For the coal flying dust generated during coal conveying, at present, a commonly used method is to use spray water or a water mist to suppress dust. This method has the following problems:

Equipment for dust suppression by spraying or adopting a water mist at the same time is relatively complex, very small spray holes and water flow channels have high requirements on water quality, otherwise, the nozzle will be blocked and cannot be used. However, in the process of coal conveying, in order to clean the site environment, suppress flying dust and protect the environment, the water spraying method always runs through the whole production and operation process. Obviously, this process needs to consume a large amount of clean water, and at the same time, a large number of equipment for dust suppression by spraying or adopting the water mist need to be arranged on the coal conveying site.

In view of the need to clean the accumulated coal on the site and equipment during coal conveying to keep the equipment and site clean and safe, a commonly used method is to use hydraulic flushing and cleaning. This method has the following problems:

to clean the accumulated coal on the site and equipment by hydraulic flushing, in addition to the need of arranging a large number of water flushing equipment on the coal conveying site, firstly, a large amount of clean water will be consumed, and meanwhile, a large amount of coal-containing wastewater is inevitably produced. In order to meet the requirements of reuse or discharge, secondly, the treatment of the coal-containing wastewater needs to adopt a complex method and consume a lot of energy to separate coal and water from the coal-containing wastewater. The recovered water can continue to flush the site, while the coal is recovered. This process greatly increases the cost of the enterprise.

In addition, the recycling of coal from the coal-containing wastewater requires a lot of manpower and material resources.

### SUMMARY

An object of the present disclosure is to provide a coal-containing wastewater spraying device for dust suppression during coal conveying in order to overcome the defects existing in the prior art, the device is simple in structure, not easy to block and high in reliability, can use a coal-containing wastewater after preliminary precipitation as spraying water, and greatly saves the manpower and material costs required in the dust suppression process, the coal-containing wastewater treatment and purification process and the coal recovery process.

The object of the present disclosure can be achieved by the following technical solution:

a coal-containing wastewater spraying device for dust suppression during coal conveying includes a motor, a gland, a body seat, and an accelerator, wherein the body seat includes a funnel-shaped cover, a first disc and a plurality of crushing plates, the plurality of the crushing plates are circumferentially arranged on an inner side wall of the cover at intervals, and close to a large caliber end of the cover, the first disc is arranged to seal a small caliber end of the cover, the accelerator includes a circular second disc, the end of an output shaft of the motor is arranged to pass through the first disc to connect with the second disc, the second disc is arranged close to the large caliber end of the cover, and a first spacing is formed between the second disc and the inner side wall of the cover, the cover is provided with a water retaining ring between the first disc and the second disc along its axial direction, a diameter of the water retaining ring is smaller than a diameter of the second disc, and a second spacing is formed between the water retaining ring and the second disc, the cover, the first disc, the second disc and the water retaining ring form a water inlet space, and the side wall of the cover is provided with a water inlet pipe communicating the water inlet space with an outside of the cover; and

wherein during use of the device, the output shaft drives the second disc to rotate, a coal-containing wastewater after preliminary precipitation is fed into the water inlet space by the water inlet pipe, first accumulates on the second disc, driven by the second disc to rotate, and is thrown to the side wall of the cover along the tangential direction of the circumference of the second disc through the second spacing under the action of centrifugal force, at this time, the velocity of the coal-containing wastewater is the same as the linear velocity of the edge of the second disc, the coal-containing wastewater impacts the crushing plates, so previously larger water droplets are decomposed into smaller water droplets under the impact of a water flow, and the smaller water droplets are sprayed to the outside of the cover through the first spacing under the action of centrifugal force, and bonded with fine coal particles in the coal flying dust, thus playing a role in suppressing the flying dust;

the water inlet space can ensure that the coal-containing wastewater entering the cover from the water inlet pipe first accumulates in the water inlet space, so as to avoid the impact of the incoming coal-containing wastewater on a certain fixed position, and the coal-containing wastewater can be quickly dispersed to the surface of the rotating second disc;

the coal-containing wastewater is a mixture of water, small coal particles, coal flocs and various chemical components, the very small spray holes and water flow channels in conventional water nozzles are very easy to block by coal with various particle sizes in the coal-containing wastewater, so the water nozzles can not adapt to this water quality and can not play the role of spraying, since the first spacing is formed between the second disc and the inner side wall of the cover, and the crushing plates will not be touched, the space of a position where the coal-containing wastewater flows through is enough to meet the passage of objects or coal with particle diameter entrained in the coal-containing wastewater. At the same time, under the action of centrifugal force, the coal-containing wastewater is difficult to deposit inside, thus ensuring that the large-particle coal entrained in the coal-containing wastewater will not be blocked, and ensuring that the spraying device can operate continuously and stably when spraying the coal-containing wastewater; and

the coal-containing wastewater can be used as dust suppression spraying water after preliminary precipitation, which simplifies the recovery and treatment process of the coal-containing wastewater and greatly saves the manpower and material costs required in the dust suppression process.

Further, the second disc is circumferentially provided with a plurality of radial water baffles at uniform intervals, each of the radial water baffles is a sector-shaped column, the sector is concentric with the second disc, and the radial water baffles can make the coal-containing wastewater accumulated on the second disc rotate with the second disc to accelerate the coal-containing wastewater, so as to disperse the coal-containing wastewater evenly and quickly and improve the spraying effect of the spraying device.

Further, each of the crushing plates is provided with a plurality of convex ridges at uniform intervals to intensify the impact effect of the water flow, make the water flow dispersion effect better, further refine the particle size of water droplets and improve the spraying effect.

Further, an included angle is formed between a plane where the crushing plates are located and the axis of the cover, and the normal of the plane where the crushing plates are located is towards a direction away from the spraying device, so that the impacted water droplets will move away from the spraying device, thereby expanding the spraying range of the spraying device.

Further, the cover includes a third cover, a first cover and a second cover which are successively connected, the first cover and the second cover have a circular truncated cone shape, an inclination angle of an outer side wall of the first cover is smaller than an inclination angle of an outer side wall of the second cover, and the crushing plates are arranged on an inner side wall of the second cover, so that the inclination angle of each crushing plate relative to the axial direction is more matched with the coal-containing wastewater thrown out by the second disc, and the water flow dispersion effect is better.

Further, the cover is coaxially provided with a connection flange at an end thereof, the motor is provided with a shaft end flange, and the shaft end flange is fixedly connected with the connection flange.

Further, the device further includes a gland and a seal, wherein the first disc is provided with a mounting groove matched with the seal, the mounting groove is provided with a first shaft hole at the bottom thereof, the output shaft passes through the first shaft hole, the seal sleeves the output shaft and is located within the mounting groove, the gland sleeves the output shaft to seal the mounting groove, and the seal is hooped on the outer cylindrical surface of the output shaft, which can prevent water from flowing to the motor along the output shaft and play a sealing role.

Further, the seal is a skeletal rubber sealing ring, and its rubber lip has elasticity, good sealing performance and good corrosion resistance.

Further, the gland is provided with a positioning shoulder matched with the mounting groove, and the positioning shoulder is located within the mounting groove, and the positioning shoulder can realize the positioning of the gland, and can press the seal tightly to improve the sealing effect.

Further, the output shaft is fixedly connected to the second disc through a second shaft hole, the output shaft is provided with a key on an end thereof, the second disc is provided with a central cylinder, the central cylinder is provided with the second shaft hole matched with the output shaft, the second shaft hole is provided with a keyway on an inner side wall thereof to match with the key, the end of the output shaft extends into the second shaft hole, the key is located within the keyway, and the output shaft drives the second disc to rotate through the key and the keyway.

Compared with the prior art, the device of the present disclosure has the following beneficial effects:

(1) according to the present disclosure, the cover, the first disc, the second disc and the water retaining ring form the water inlet space, the side wall of the cover is provided with the water inlet pipe communicating the water inlet space with the outside of the cover, the accelerator includes the circular second disc which is in transmission connection with the output shaft of the motor, the first spacing is formed between the second disc and the inner side wall of the cover, the second spacing is formed between the water retaining ring and the second disc, thus the water flow channel degree inside the spraying device is larger than the diameter of the various particles entrained in the coal-containing wastewater, so that the coal blocking phenomenon does not occur, so as to ensure that the spraying device can operate continuously and stably when spraying the coal-containing wastewater with high reliability, the coal-containing wastewater is fed into the water inlet space by the water inlet pipe, first accumulates on the second disc, and is thrown to the side wall of the cover along the tangential direction of the circumference of the second disc through the second spacing under the driving of the second disc, at this time, the velocity of the coal-containing wastewater is the same as the linear velocity of the edge of the second disc, the coal-containing wastewater impacts the crushing plates, during the impact, previously larger water droplets are decomposed into smaller water droplets, the smaller water droplets are sprayed to the outside of the cover through the first spacing under the action of centrifugal force, and bonded with fine coal particles in the coal flying dust, thus playing a role in suppressing the flying dust, the accelerator is driven by the motor, and the device has a simple structure and a low failure rate;

(2) the water inlet space of the present disclosure can ensure that the coal-containing wastewater entering the cover from the water inlet pipe is first accumulated in the water inlet space, so as to avoid the impact of the incoming coal-containing wastewater on a certain fixed position, and the coal-containing wastewater can be quickly dispersed;

(3) the device of present disclosure can use the coal-containing wastewater after preliminary precipitation, so that a large amount of coal-containing wastewater generated during the cleaning of the coal conveying site can be consumed, there is no need to invest complex and expensive water purification equipment in order to treat the coal-containing wastewater, the recovery and treatment process of the coal-containing wastewater is simplified, at the same time, direct use of the coal-containing wastewater can save a large amount of clean water consumed by the conventional spraying device during dust suppression spraying, and using the coal-containing wastewater as spraying water can directly recover the coal in the wastewater, which greatly saves the manpower and material costs required in the dust suppression process and the purification treatment process of the coal-containing wastewater;

(4) the second disc of present disclosure is circumferentially provided with the plurality of the radial water baffles at uniform intervals, each of the radial water baffles is the sector-shaped column, the sector is concentric with the second disc, and the radial water baffles can accelerate the coal-containing wastewater accumulated on the second disc, disperse the coal-containing wastewater evenly and quickly and improve the spraying effect of the spraying device;

(5) each of the crushing plates of the present disclosure is provided with the plurality of the convex ridges at uniform intervals to intensify the impact effect of the water flow, make the water flow dispersion effect better, further refine the particle size of water droplets and improve the spraying dust suppression effect;

(6) according to the present disclosure, the included angle is formed between the plane where the crushing plates are located and the axis of the cover, and the normal of the plane where the crushing plates are located is towards the direction away from the spraying device, so that the impacted water droplets will move away from the spraying device, so as to avoid the water droplets from flying into the spraying device, improve the efficiency of refining water droplets and expand the spraying range of the spraying device;

(7) the cover of the present disclosure includes the third cover, the first cover and the second cover which are successively connected, the first cover and the second cover have the circular truncated cone shape, the inclination angle of the outer side wall of the first cover is smaller than the inclination angle of the outer side wall of the second cover, and the crushing plates are arranged on the inner side wall of the second cover, so that the inclination angle of each crushing plate relative to the axial direction is more matched with the coal-containing wastewater thrown out by the second disc, and the water flow dispersion effect is better;

(8) the device of the present disclosure further includes the gland and the seal, wherein the first disc is provided with the mounting groove matched with the seal, the mounting groove is provided with the first shaft hole at the bottom thereof, the output shaft passes through the first shaft hole, the seal sleeves the output shaft and is located within the mounting groove, the gland sleeves the output shaft to seal the mounting groove, and the seal is hooped on the outer cylindrical surface of the output shaft, which can prevent water from flowing along the output shaft and play a sealing role;

(9) the seal of the present disclosure is the skeletal rubber sealing ring, and its rubber lip has elasticity, good sealing performance and good corrosion resistance; and

(10) the gland of the present disclosure is provided with the positioning shoulder matched with the mounting groove, the positioning shoulder is located within the mounting groove, and the positioning shoulder can realize the positioning of the gland, and can press the seal tightly to improve the sealing effect.

### BRIEF DESCRIPTION OF THE DRAWINGS

FIG. 1 is a structural schematic diagram of a motor.

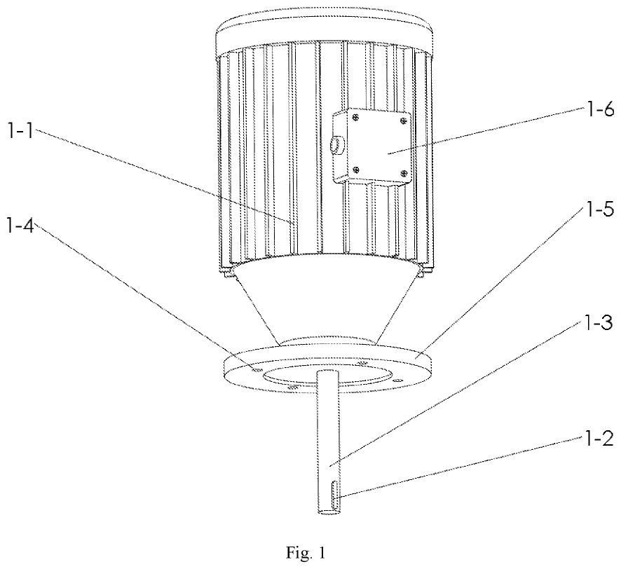

FIG. 2 is a structural cross-sectional view of a body seat.

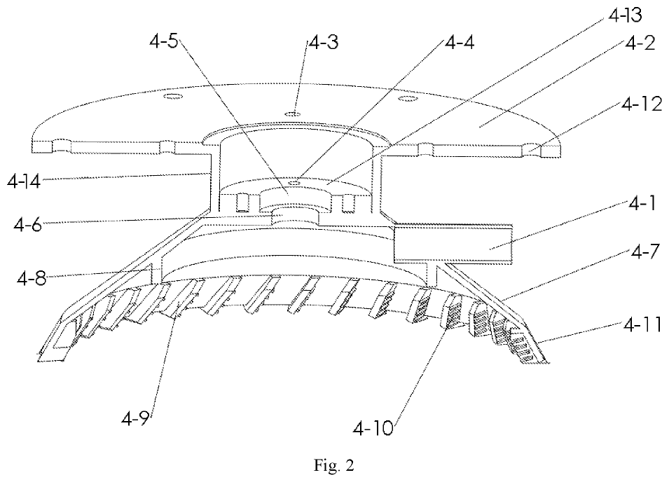

FIG. 3 is a structural schematic diagram of an accelerator.

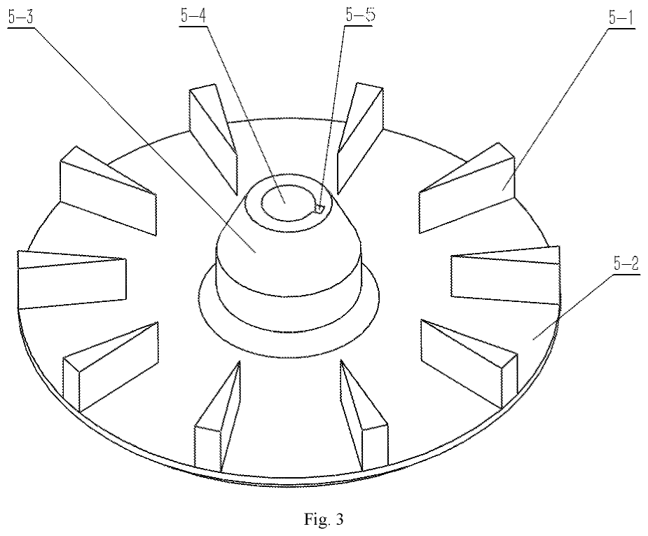

FIG. 4 is a structural schematic diagram of a gland.

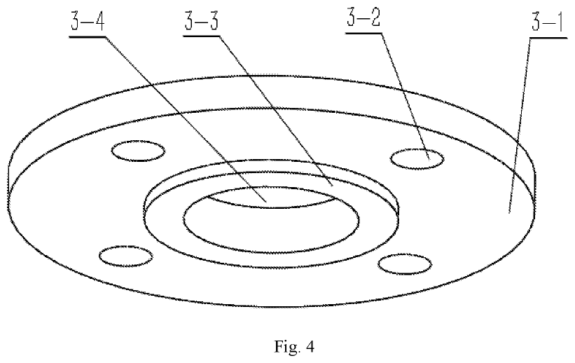

FIG. 5 is a structural cross-sectional view of the present disclosure.

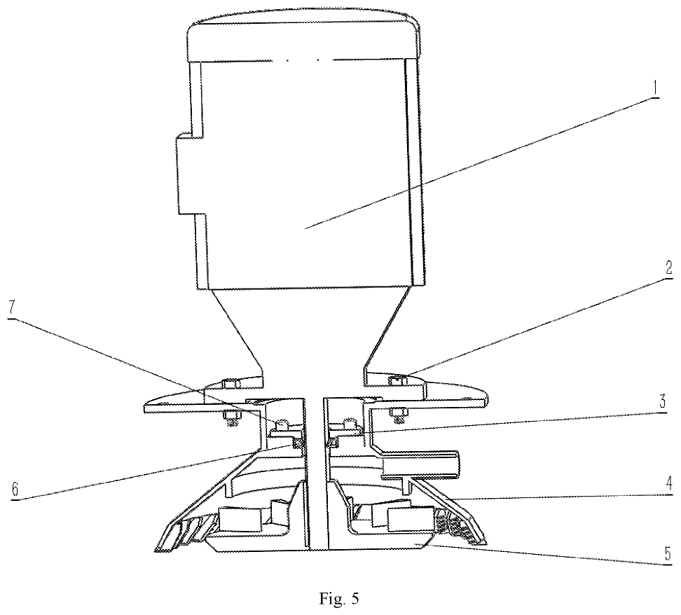

### DESCRIPTION OF REFERENCE SIGNS IN THE DRAWINGS

1. Motor, 2. First bolt, 3. Gland, 4. Body seat, 5. Accelerator, 6. Seal, 7. Second bolt, 1-1. Housing, 1-2. Key, 1-3. Output shaft, 1-4. First screw hole, 1-5. Shaft end flange, 1-6. Junction box, 3-1. Gland plate, 3-2. Fourth screw hole, 3-3. Positioning shoulder, 3-4. Third shaft hole, 4-1. Water inlet pipe, 4-2. Connection flange, 4-3. Second screw hole, 4-4. Third screw hole, 4-5. Mounting groove, 4-6. First shaft hole, 4-7. First cover, 4-8. Water retaining ring, 4-9. Crushing plate, 4-10. Convex ridge, 4-11. Second cover, 4-12. Mounting hole, 4-13. First disc, 4-14. Third cover, 5-1. Radial water baffle, 5-2. Second disc, 5-3. Central cylinder, 5-4. Second shaft hole, and 5-5. Keyway.

### DETAILED DESCRIPTION

The present disclosure will be described in detail below in combination with the accompanying drawings and specific embodiments. This embodiment is carried out on the premise of the technical solution of the present disclosure, detailed embodiments and specific operating procedures are given, but the scope of protection of the present disclosure is not limited to the embodiments described below.

A coal-containing wastewater spraying device for dust suppression during coal conveying, including a motor 1, a gland 3, a body seat 4 and an accelerator 5, wherein the body seat 4 includes a funnel-shaped cover, a first disc 4-13 and a plurality of crushing plates 4-9, the plurality of the crushing plates 4-9 are circumferentially arranged on an inner side wall of the cover at intervals, and close to a large caliber end of the cover, the first disc 4-13 is arranged to seal a small caliber end of the cover, the accelerator 5 includes a circular second disc 5-2, the end of an output shaft 1-3 of the motor 1 is arranged to pass through the first disc 4-13 to connect with the second disc 5-2, the second disc 5-2 is arranged close to the large caliber end of the cover, and a first spacing is formed between the second disc 5-2 and the inner side wall of the cover, the cover is provided with a water retaining ring 4-8 between the first disc 4-13 and the second disc 5-2 along its axial direction, a diameter of the water retaining ring 4-8 is smaller than a diameter of the second disc 5-2, and a second spacing is formed between the water retaining ring 4-8 and the second disc 5-2, the cover, the first disc 4-13, the second disc 5-2 and the water retaining ring 4-8 form a water inlet space, and the side wall of the cover is provided with a water inlet pipe 4-1 communicating the water inlet space with an outside of the cover;

the motor 1 is a 2-pole motor with a synchronous speed close to 3000 r/min; the linear velocity on the circumference of the second disc 5-2 is the product of the speed and the circumference; the larger the circumference of the second disc 5-2, the higher the linear velocity; and the motor 1 is provided with a junction box 1-6;

during use of the device, the output shaft 1-3 drives the second disc 5-2 to rotate, a coal-containing wastewater after preliminary precipitation is fed into the water inlet space by the water inlet pipe 4-1, first accumulates on the second disc 5-2, driven by the second disc 5-2 to rotate, and is thrown to the side wall of the cover along the tangential direction of the circumference of the second disc 5-2 through the second spacing under the action of centrifugal force, at this time, the velocity of the coal-containing wastewater is the same as the linear velocity of the edge of the second disc 5-2, the coal-containing wastewater impacts the crushing plates 4-9, so previously larger water droplets are decomposed into smaller water droplets under the impact of a water flow, and the smaller water droplets are sprayed to the outside of the cover through the first spacing under the action of centrifugal force, and bonded with fine coal particles in the coal flying dust, thus playing a role in suppressing the flying dust;

the water inlet space can ensure that the coal-containing wastewater entering the cover from the water inlet pipe 4-1 first accumulates in the water inlet space, so as to avoid the impact of the incoming coal-containing wastewater on a certain fixed position, and the coal-containing wastewater can be quickly dispersed;

the coal-containing wastewater is a mixture of water, small coal particles, coal flocs and various chemical components, the very small spray holes and water flow channels in conventional water nozzles are very easy to block by coal with various particle sizes in the coal-containing wastewater, so the water nozzles can not adapt to this water quality and can not play the role of spraying, since the first spacing is formed between the second disc 5-2 and the inner side wall of the cover, and the crushing plates 4-9 will not be touched, the space of a position where the coal-containing wastewater flows through is enough to meet the passage of objects or coal with particle diameter entrained in the coal-containing wastewater. At the same time, under the action of centrifugal force, the coal-containing wastewater is difficult to deposit inside, thus ensuring that large particles with a relatively large diameter entrained in the coal-containing wastewater will not be blocked, and ensuring that the spraying device can operate continuously and stably when spraying the coal-containing wastewater; and

the coal-containing wastewater can be used as dust suppression spraying water after preliminary precipitation, which simplifies the recovery and treatment process of the coal-containing wastewater and greatly saves the manpower and material costs required in the dust suppression process; and collection of the coal-containing wastewater on coal conveying sites is mainly achieved by means of a coal slime pond, and the coal slime pond has the characteristics of preliminary sedimentation, so the large particles or coal that can be entrained by the coal-containing wastewater have precipitated in the coal slime pond. However, the diameter of particles contained in the coal-containing wastewater used for spraying is less than 20 mm, so there is no large-particle coal, and these coal particles do not affect the spraying device.

The second disc 5-2 is circumferentially provided with a plurality of radial water baffles 5-1 at uniform intervals, each of the radial water baffles 5-1 is a sector-shaped column, the sector is concentric with the second disc 5-2, and the radial water baffles 5-1 can disperse the coal-containing wastewater accumulated on the second disc 5-2 evenly and quickly, and improve the spraying effect of the spraying device.

Each of the crushing plates 4-9 is provided with a plurality of convex ridges 4-10 at uniform intervals to intensify the impact effect of the water flow, make the water flow dispersion effect better, further refine the particle size of water droplets and improve the spraying effect.

An included angle is formed between a plane where the crushing plates 4-9 are located and the axis of the cover, and the normal of the plane where the crushing plates 4-9 are located is towards a direction away from the spraying device, so that the impacted water droplets will move away from the spraying device, thereby expanding the spraying range of the spraying device.

The rotation direction of the second disc 5-2 is to make the thrown coal-containing wastewater directly impact the surfaces with the convex ridges 4-10 on the crushing plates 4-9, otherwise the spraying device cannot work normally.

The cover includes a third cover 4-14, a first cover 4-7 and a second cover 4-11 which are successively connected, the first cover 4-7 and the second cover 4-11 have a circular truncated cone shape, an inclination angle of an outer side wall of the first cover 4-7 is smaller than an inclination angle of an outer side wall of the second cover 4-11, and the crushing plates 4-9 are arranged on an inner side wall of the second cover 4-11, so that the inclination angle of each crushing plate 4-9 relative to the axial direction is more matched with the coal-containing wastewater thrown out by the second disc 5-2, and the water flow dispersion effect is better.

The cover is coaxially provided with a connection flange 4-2 at an end thereof, the motor 1 is provided with a shaft end flange 1-5, the shaft end flange 1-5 is provided with first screw holes 1-4, the connection flange 4-2 is provided with second screw holes 4-3, and mounting holes 4-12, the shaft end flange 1-5 is fixedly connected with the connection flange 4-2 through first bolts 2 passing through the first screw holes 1-4 and the second screw holes 4-3, and the spraying device is fixed in position by the mounting holes 4-12.

The device further includes a gland 3 and a seal 6, wherein the first disc 4-13 is provided with a mounting groove 4-5 matched with the seal 6, the mounting groove 4-5 is provided with a first shaft hole 4-6 at the bottom thereof, the output shaft 1-3 passes through the first shaft hole (4-6), the seal 6 sleeves the output shaft 1-3 and is located within the mounting groove 4-5, the gland 3 is provided with a third shaft hole 3-4, and sleeves the output shaft 1-3 through the third shaft hole 3-4 to seal the mounting groove 4-5, and the seal 6 is hooped on the outer cylindrical surface of the output shaft 1-3, which can prevent water from flowing along the output shaft 1-3 and play a sealing role.

The seal 6 is a skeletal rubber sealing ring, and its rubber lip has elasticity, and good sealing performance.

The gland 3 is provided with fourth screw holes 3-2, the first disc 4-13 is provided with third screw holes 4-4, and the gland 3 is fixed to the first disc 4-13 through second bolts 7 passing through the fourth screw holes 3-2 and the third screw holes 4-4; and

the gland 3 is provided with a positioning shoulder 3-3 matched with the mounting groove 4-5, the positioning shoulder 3-3 is located within the mounting groove 4-5, and the positioning shoulder 3-3 can realize the positioning of the gland 3, and can press the seal 6 tightly to improve the sealing effect.

The output shaft 1-3 is provided with a key 1-2 on an end thereof, the second disc 5-2 is provided with a central cylinder 5-3, the central cylinder 5-3 is provided with a second shaft hole 5-4 matched with the output shaft 1-3, the second shaft hole 5-4 is provided with a keyway 5-5 on an inner side wall thereof to match with the key 1-2, the end of the output shaft 1-3 extends into the second shaft hole 5-4, and the key 1-2 is located within the keyway 5-5.

The present embodiment provides the coal-containing wastewater spraying device for dust suppression during coal conveying, which has simple structure and is safe and reliable, the accelerator 5 is used to accelerate the coal-containing wastewater flowing into the spraying device, so that the coal-containing wastewater reaches a higher speed, and impacts the crushing plates 4-9, the water is decomposed into a large number of water droplets with a smaller diameter under the action of impact force, the dust suppression function is realized through the combination of these water droplets and the flying dust generated during coal conveying, the water flow channel degree inside the spraying device is larger than the diameter of the various particles entrained in the coal-containing wastewater, so that the coal blocking phenomenon does not occur, by selecting the 2-pole motor to obtain a higher speed to drive the accelerator, the structure is relatively simple and the failure rate is low, which can meet the continuous and stable operation of the coal conveying site;

the spraying device can use the coal-containing wastewater, so that a large amount of coal-containing wastewater generated during the cleaning of the coal conveying site can be consumed, there is no need to invest complex and expensive water purification equipment in order to treat the coal-containing wastewater, at the same time, direct use of the coal-containing wastewater can save a large amount of clean water consumed by the conventional spraying device during dust suppression spraying, and using the coal-containing wastewater as spraying water can directly recover the coal in the wastewater; and

the spraying device proposed in this embodiment uses the coal-containing wastewater after preliminary precipitation, which is a brand-new treatment method for treating the coal-containing wastewater generated during coal conveying, and is an improvement compared with the original process flow of separating dust suppression spraying from wastewater recovery and treatment, the traditional process method consumes water and energy, and the treatment equipment is expensive. Compared with such traditional methods, the spraying device proposed in this embodiment will produce greater economic benefits.

Preferred embodiments of the present disclosure are described in detail above. It should be understood that numerous modifications and variations can be made in accordance with the concept of the present disclosure by those of ordinary skill in the art without inventive work. Therefore, any technical solution that can be obtained by those skilled in the art through logical analysis, reasoning or limited experiments on the basis of the prior art according to the concept of the present disclosure shall be within the protection scope determined by the claims.

We claim:

1. A coal-containing wastewater spraying device for dust suppression during coal conveying, comprising a motor (1), a gland (3), a body seat (4) and an accelerator (5), wherein the body seat (4) comprises a funnel-shaped cover, a first disc (4-13) and a plurality of crushing plates (4-9),
the plurality of the crushing plates (4-9) are circumferentially arranged on an inner side wall of the cover at intervals, and close to a large caliber end of the cover,
the first disc (4-13) is arranged to seal a small caliber end of the cover,
the accelerator (5) comprises a circular second disc (5-2),
the end of an output shaft (1-3) of the motor (1) is arranged to pass through the first disc (4-13) to connect with the second disc (5-2),
the second disc (5-2) is arranged close to the large caliber end of the cover, and a first spacing is formed between the second disc (5-2) and the inner side wall of the cover,
the cover is provided with a water retaining ring (4-8) between the first disc (4-13) and the second disc (5-2) along its axial direction, a diameter of the water retaining ring (4-8) is smaller than a diameter of the second disc (5-2), and a second spacing is formed between the water retaining ring (4-8) and the second disc (5-2),
the cover, the first disc (4-13), the second disc (5-2) and the water retaining ring (4-8) form a water inlet space, and
the side wall of the cover is provided with a water inlet pipe (4-1) communicating the water inlet space with an outside of the cover; and
wherein during use of the device, the output shaft (1-3) drives the second disc (5-2) to rotate, a coal-containing wastewater after preliminary precipitation is fed into the water inlet space by the water inlet pipe (4-1), accumulates on the second disc (5-2), starts to rotate and accelerate under the driving of the second disc (5-2), is thrown to the side wall of the cover through the second spacing under the action of centrifugal force, and impacts the crushing plates (4-9), so previously larger water droplets are decomposed into smaller water droplets, and the smaller water droplets are sprayed to the outside of the cover through the first spacing under the action of centrifugal force.

2. The coal-containing wastewater spraying device for dust suppression during coal conveying of claim 1, wherein the second disc (5-2) is circumferentially provided with a plurality of radial water baffles (5-1) at uniform intervals, each of the radial water baffles (5-1) is a sector-shaped column, and the sector is concentric with the second disc (5-2).

3. The coal-containing wastewater spraying device for dust suppression during coal conveying of claim 1, wherein each of the crushing plates (4-9) is provided with a plurality of convex ridges (4-10) at uniform intervals.

4. The coal-containing wastewater spraying device for dust suppression during coal conveying of claim 1, wherein an included angle is formed between a plane where the crushing plates (4-9) are located and the axis of the cover.

5. The coal-containing wastewater spraying device for dust suppression during coal conveying of claim 1, wherein the cover comprises a third cover (4-14), a first cover (4-7) and a second cover (4-11) which are successively connected, the first cover (4-7) and the second cover (4-11) have a circular truncated cone shape, an inclination angle of an outer side wall of the first cover (4-7) is smaller than an inclination angle of an outer side wall of the second cover (4-11), and the crushing plates (4-9) are arranged on an inner side wall of the second cover (4-11).

6. The coal-containing wastewater spraying device for dust suppression during coal conveying of claim 1, wherein the cover is coaxially provided with a connection flange (4-2) at an end thereof, the motor (1) is provided with a shaft end flange (1-5), and the shaft end flange (1-5) is fixedly connected with the connection flange (4-2).

7. The coal-containing wastewater spraying device for dust suppression during coal conveying of claim 1, further comprising a gland (3) and a seal (6), wherein the first disc (4-13) is provided with a mounting groove (4-5) matched with the seal (6), the mounting groove (4-5) is provided with a first shaft hole (4-6) at the bottom thereof, the output shaft (1-3) passes through the first shaft hole (4-6) , the seal (6) sleeves the output shaft (1-3) and is located within the mounting groove (4-5), and the gland (3) sleeves the output shaft (1-3) to seal the mounting groove (4-5).

8. The coal-containing wastewater spraying device for dust suppression during coal conveying of claim 7, wherein the seal (6) is a skeletal rubber sealing ring.

9. The coal-containing wastewater spraying device for dust suppression during coal conveying of claim 7, wherein the gland (3) is provided with a positioning shoulder (3-3) matched with the mounting groove (4-5), and the positioning shoulder (3-3) is located within the mounting groove (4-5).

10. The coal-containing wastewater spraying device for dust suppression during coal conveying of claim 1, wherein the output shaft (1-3) is provided with a key (1-2) on an end thereof, the second disc (5-2) is provided with a central cylinder (5-3), the central cylinder (5-3) is provided with a second shaft hole (5-4) matched with the output shaft (1-3), the second shaft hole (5-4) is provided with a keyway (5-5) on an inner side wall thereof to match with the key (1-2), the end of the output shaft (1-3) extends into the second shaft hole (5-4), and the key (1-2) is located within the keyway (5-5).
